(19) United States
(12) Patent Application Publication
(10) Pub. No.: US 2026/0210331 A1
(43) Pub. Date: Jul. 23, 2026

(54) HYBRID SOLAR CHIMNEY

(71) Applicant: SÜLEYMAN DEMIREL ÜNIVERSITESI IDARI VE MALI ISLER DAIRE BASKANLIGI GENEL SEKRETERLIK, ISPARTA (TR)

(72) Inventor: Ibrahim ÜÇGÜL, ISPARTA (TR)

(21) Appl. No.: 18/873,740

(22) PCT Filed: Jan. 8, 2024
(86) PCT No.: PCT/TR2024/050009

§ 371 Date: Dec. 11, 2024

(51) Int. Cl. F03D 9/41; F03G 6/04

(52) U.S. Cl. CPC F03D 9/41; F03G 6/045; F05B 2220/706; F05B 2240/9111; F05B 2260/24

(57) ABSTRACT

Disclosed herein is a hybrid solar chimney to provide energy gain, including at least one chimney where the suction-draft process (vacuum effect) results in air whose density is reduced by the horizontal wing and at least one greenhouse to heat the air in the chimney.

This application is a National Phase entry of International Application No. PCT/TR2024/050009 under § 371, which is hereby incorporated by reference in its entirety.

### FIELD OF THE DISCLOSURE

The present disclosure relates to a hybrid solar chimney that can operate day and night in both summer and winter seasons, by means of the vacuum effect it creates within the chimney.

### BACKGROUND

Aside from the fact that fossil-based fuels, which are widely used today, are externally dependent and costly, are not renewable resources and will therefore run out after a certain period of time, the environmental hazards caused by the greenhouse effect created by the carbon dioxide produced by burning them have increased the importance of alternative energy sources.

One of the easiest and most widely used of these resources is solar energy. Among solar energy systems, one of the important alternatives that stands out in terms of usage potential and advantages among solar power systems is solar power systems with solar chimneys.

Solar chimneys convert the incoming sunlight into motion energy and then into electrical energy, using the principle of the greenhouse effect. Here, the greenhouse effect principle can be considered together with chimney draft, turbine and generator. The solar chimney physically consists of a collector (greenhouse)—preferably glass—, a chimney and (single or multiple) turbines.

Solar chimneys are energy conversion systems that first convert solar energy into thermal energy, then thermal energy into kinetic energy and finally into electrical energy. Solar chimneys consist of a greenhouse collector section that collects solar energy and transfers it to the air circulating inside, and a long chimney section containing a wind turbine electricity generation system.

The solar chimney consists of a central chimney with a large transparent collector greenhouse underneath and a wind turbine inside. Warm air is produced by the collector greenhouse using solar radiation (direct and diffuse beam). The heated air in the greenhouse area directs towards the chimney in the centre of the collector and produces energy by moving the turbine in the middle.

Technologies that produce energy from the sun are expensive today. The fact that solar chimneys have to be built in very high heights for drafting and that they require the use of large greenhouse areas to heat the air increases the investment costs considerably.

In addition, existing solar chimneys can produce energy only during the day and in the months when solar radiation is high, by using only solar energy to produce energy. In other words, existing solar chimneys can only produce electricity during the summer season and only during the day in this season. This situation significantly reduces the annual efficiency of existing solar chimney systems. As a result, current solar chimney technologies have low efficiency, long payback periods and high investment costs.

A solar chimney configuration is described in the international application with the publication number WO2019164463 (A1) in the state of the art, and in the application with the Turkish national entry number TR2020/13103. The invention that is the subject of the application is related to a solar chimney configuration used to generate electrical energy from solar energy using a thermal method; and the air flows transferred by both updraft and downdraft chimneys are used through the three-piece chimney system used in the configuration of the invention, and as a result, highly efficient energy is obtained through vertical turbines placed at the entrances of the chimneys.

In the document numbered EP2524137A1 in the state of the art, a wind turbine solar chimney is mentioned. A solar chimney generally comprises a tall chamber with an hourglass configuration. The chamber comprises one or more heat exchangers for solar heating of the air in the chamber. A turbine in the chamber is driven by the upward pull of air created in the chamber, and the turbine drives an electrical generator or other machine. An exhaust wind turbine helps produce such updrafts. A vertical axis wind turbine utilises wind energy in the stack environment, and this energy is used to drive the exhaust wind turbine. Excess wind energy is stored for later use. A series of extendible and retractable blades mounted on the outside of the chimney direct wind in the chimney environment towards the vertical axis wind turbine.

To determine the known state of the art, documents such as TR2015/11926, TR2013/03287, US20120153628A1, U.S. Pat. No. 4,706,471, WO2004085846 (A1), CN2651663 (Y) and CN102536693 (A) can be examined.

As a result, improvements are being made in solar chimney systems, so new applications are needed that will eliminate the disadvantages mentioned above and provide solutions to existing applications.

### SUMMARY

The present disclosure relates to a hybrid solar chimney and operating method that meets the above-mentioned requirements, eliminates all disadvantages and brings some additional advantages.

One objective of at least one embodiment of the invention is to introduce a hybrid solar chimney that can operate day and night in both summer and winter seasons, by means of the vacuum effect it creates inside the chimney, and working method thereof.

Another objective of at least one embodiment of the invention is to introduce a hybrid solar chimney that offers an alternative energy production method to the problems of fossil-based fuels being externally dependent and costly, not being a renewable resource and therefore depleting after a certain period of time, and working method thereof.

Another objective of at least one embodiment of the invention is to introduce a hybrid solar chimney that offers an alternative energy production method to prevent environmental hazards caused by the greenhouse effect caused by carbon dioxide resulting from the burning of fossil-based fuels, and working method thereof.

Another objective of at least one embodiment of the invention is to introduce a hybrid solar chimney that enables cheap energy production by means of its efficient structure, and working method thereof.

Another objective of at least one embodiment of the invention is to introduce a hybrid solar chimney that, by means of its efficient structure, avoids the need to produce solar chimneys with high and thick bodies, and working method thereof.

Another objective of at least one embodiment of the invention is to introduce a hybrid solar chimney that, by means of its efficient structure, eliminates the need for solar chimneys to use large greenhouse areas to heat the incoming air, and working method thereof.

Another objective of at least one embodiment of the invention is to introduce a hybrid solar chimney that reduces the investment costs of solar chimneys, shortens the payback period and increases their efficiency, and working method thereof.

The structural and characteristic features and all the advantages of embodiments of the invention will be understood more clearly by means of the figures given below and the detailed explanation written with references to these figures. For this reason, the assessment should be made by taking these figures and detailed explanation into consideration.

### BRIEF DESCRIPTION OF THE DRAWINGS

FIG. 1 shows the general view of at least one embodiment of the invention.

FIG. 2 shows the visual of the chimney draft mechanism.

FIG. 3 shows the separated view of the elements in FIG. 1.

FIG. 4 shows the view of the sensor mechanisms.

FIG. 5 shows the detailed view of the lower part of at least one embodiment of the invention.

FIG. 6 shows the view of the chimney.

FIG. 7 shows the detailed view of the chimney.

FIG. 8 shows the view of the side opening.

### DETAILED DESCRIPTION

This detailed description is explained only for a better understanding of the subject and in a way that does not create any limiting effect.

The following are reference numbers used in the drawings.
E1. First axis
E2. Second axis
Q1. First opening
Q2. Second opening
1. Chimney draft mechanism
   11. Horizontal wing
   12. Wing carrier
   13. Translation element 1
   14. Translation element 2
   15. Angle adjustment element
   16. Slewing bearing
   17. Tail wing
2. Chimney
3. Greenhouse
   31. Cover
   33. Air router
4. Power generation mechanism
   42. Turbine blade
5. Control Unit
6. Warning evaluation unit
   61. Warning unit 1
   62. Warning unit 2
   63. Warning unit 3
   64. Warning unit 4
   65. Warning unit 5
7. Balancing element

At least one embodiment of the invention creates energy gain by revealing the preferred configurations/embodiments of the hybrid solar chimney (2).

At least one embodiment of the invention comprises elements the functions of which are shared within the scope of the disclosure described below.
There is a chimney draft mechanism (1) connected to the top of the solar chimney (2) to ensure the air draft inside the chimney (2) and to ensure the operation of said solar chimneys (2), especially in dark weather and winter seasons when sunlight is insufficient.
There is a horizontal wing (11) that divides the wind energy transmitted to it into two, top and bottom, according to its location, allows the wind energy at the bottom to be faster than the wind energy at the top, and to provide air draft by creating a vacuum effect, as the wind energy at the bottom is faster than the wind energy at the top.
There is a wing carrier (12) on which the translation system 1 (13), the translation system 2 (14) and the angle adjustment element (15) are positioned to ensure the preservation of said elements.
There is a translation element 1 (13) to provide forward-backward movement of said horizontal wing (11) in the direction of the horizontal axis (E2).
There is a translation element 2 (14) to provide up-down movement of said horizontal wing (11) in the direction of the vertical axis (E1).
There is an angle adjustment element (15) to adjust the position of the horizontal wing (11) according to the wind energy (wind speed) and to ensure the use of the wind energy at the most appropriate angle.
There is a slewing bearing (16) to ensure that the tail wing (17) constantly rotates towards the direction of the wind.
There is a tail wing (17) to ensure that the horizontal wing (11) constantly evolves towards the direction of the wind and to indicate the direction of the horizontal wing (11).
There is a chimney (2) where the suction-draft process (vacuum effect) is created for the air the density of which is reduced by the horizontal wing (11).
There is a greenhouse (3) to heat the air in the chimney (2).
There is a cover (31) to cover said greenhouse (3).
There is an air router (33) in said greenhouse (3) to direct the heated air to the chimney (2).
There is a power generation mechanism (4) to convert wind energy (mechanical energy) into electrical energy through alternators.
Within said power generation mechanism (4), there is a turbine blade (42) from which the necessary drive will be provided (electrical energy will be provided) to ensure the production of electricity and the operation of said power generation mechanism (4).
There is a control unit (5) that processes the information received from the warning evaluation unit (6) and, as a result of its evaluations, enables the position of the horizontal wing (11) to be adjusted in case of weather conditions suitable for its operation, provides the necessary information to the translation element 1 (13), the translation element 2 (14) and the angle adjustment element (15) in order to adjust the direction of the horizontal wing (11) according to the wind direction, and check the control and operation accuracy of said elements.
There is a warning evaluation unit (6) where the information coming from sensor groups located in different positions, angles and directions is first evaluated, the data obtained is compared and controlled according to the previously specified processing range, and then transferred to the control unit (5).
There is a warning unit 1 (61) that measures the direction angles of the solar beams and transfers the relevant data to the warning evaluation unit (6).
There is a warning unit 2 (62) that calculates the wind speed and the wind angle and transfers the relevant data to the warning evaluation unit (6).
There is a warning unit 3 (63) that calculates the air conditions in the greenhouse (3) and transfers the relevant data to the warning evaluation unit (6).
There is a warning unit 4 (64) that calculates the air temperature, air humidity and precipitation possibilities and transfers the data obtained to the warning evaluation unit (6).
There is a warning unit 5 (65) that calculates the air conditions inside the chimney (2) and transfers it to the warning evaluation unit (6).
There is a balancing element (7) that is activated in case of load imbalances that may occur on the chimney draft mechanism (1) in the direction of the first axis (E1) and/or the second axis (E2) and prevents said chimney draft mechanism (1) from being damaged due to load imbalances.

Above, the functions of the elements constituting at least one embodiment of the invention are given. In the detailed explanation below, the positions of the mentioned elements in relation to each other and their functions as a whole are given.

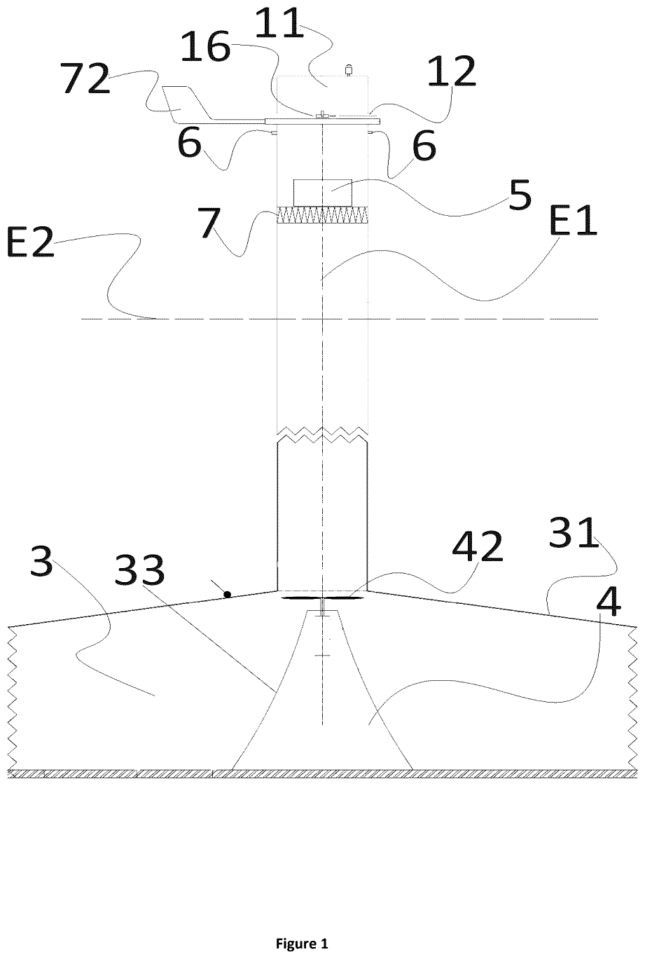

As can be seen from FIG. 1, the chimney (2) is positioned equally on both sides relative to the first axis (E1). The balancing element (7) is positioned inside the chimney (2). In an alternative embodiment of the invention, said balancing element (7) is a spring. In case of unbalanced loads on the chimney (2), in other words, if the wind blows at the expected speed and the blades cannot absorb the wind speed, the balancing element (7) is activated to prevent the chimney (2) from shaking and being damaged.

Said first axis (E1) is the horizontal axis, while said second axis (E2) is the vertical axis.

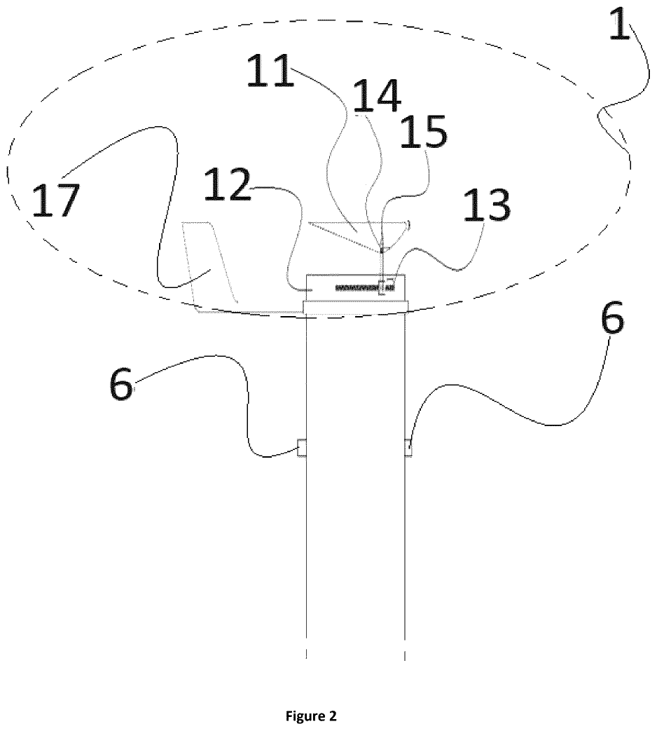

When FIG. 1 and FIG. 2 are examined together, it is seen that the chimney draft mechanism (1) is connected to the chimney (2). Said chimney draft mechanism (1) is obtained by a system consisting of horizontal wing (11), wing carrier (12), translation element 1 (13), translation element 2 (14), angle adjustment element (15), slewing bearing (16) and tail wing (17).

Horizontal wing (11) is positioned at the top of the chimney (2) according to the first axis (E1). A slewing bearing (16) is positioned at the bottom of the horizontal wing (11) in the direction of the first axis (E1). The tail wing (17) is positioned in the same direction as the slewing bearing (16), in the same direction as the second axis (E2). As can be seen from FIG. 1 and FIG. 2, the tail wing (17) is constantly moved in the direction of the first axis (E1) and rotated towards the direction of the wind, by means of the slewing bearing (16). In this way, the different directions in which the wind reaches the wing are not missed at different times of the day, and the use of wind energy is ensured at all times of the day.

Again, as can be understood from FIGS. 1 and 2, the warning evaluation unit (6) is positioned to both sides of the chimney (2) in such a way that, tail wing (17) being in line with the first axis (E1), it will remain in the bottom side of the chimney (2) in line with the second axis (E2) and again in the same direction as each other in line with the second axis (E2).

As shown in FIG. 2, the wing carrier (12) is positioned on the underside of the tail wing (17) according to the first axis (E1) direction. Said tail wing (17) is positioned on the wing carrier (12). Again, as shown in FIG. 2, translation element 1 (13), translation element 2 (14) and angle adjustment element (15) are positioned on the wing carrier (12). By means of the translation element 1 (13), the horizontal wing (11) is moved forward and backward in the direction of the second axis (E2), and by means of the translation element 2 (14), the horizontal wing (11) is moved forward and backward in the direction of the first axis (E1). By means of the angle adjustment element (15), the horizontal wing (11) is positioned according to the angle of arrival of the wind, ensuring that it is constantly at the most appropriate angle (position) at every time of the day.

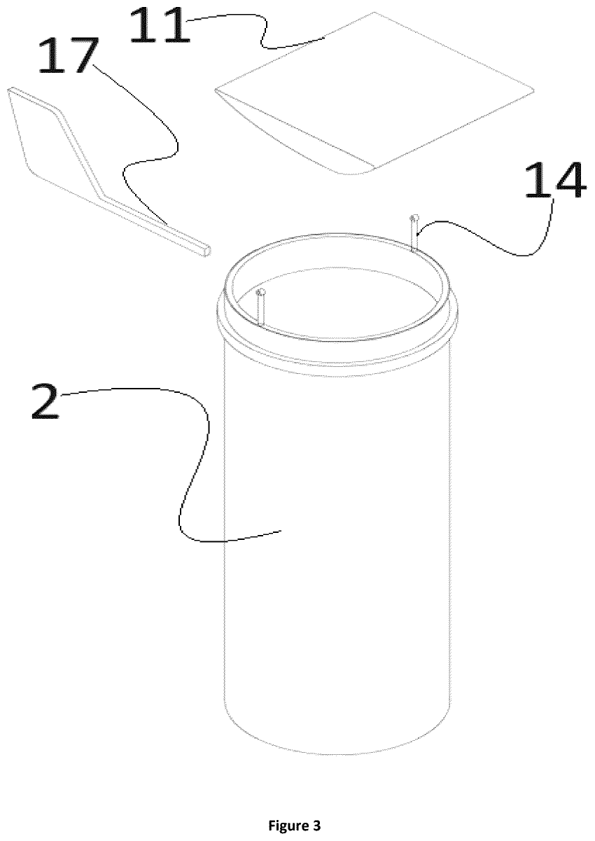

FIG. 3 shows the disassembled views of said tail wing (17) and horizontal wing (11).

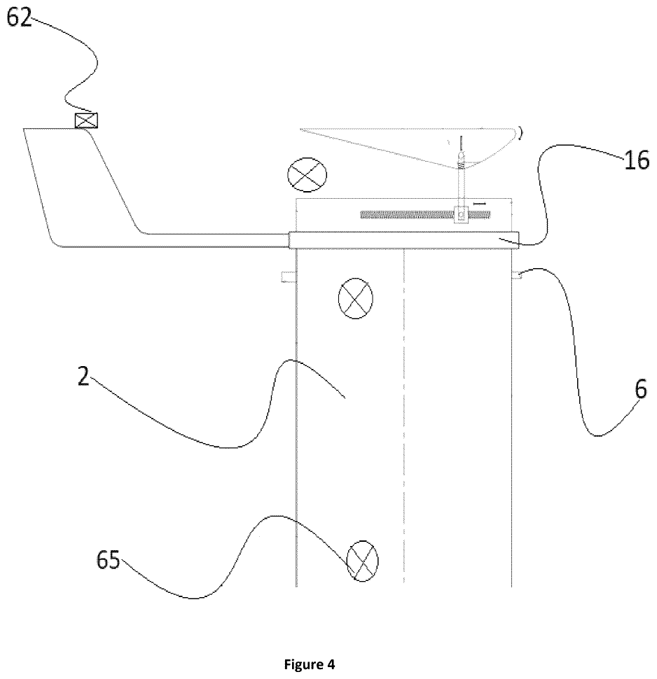

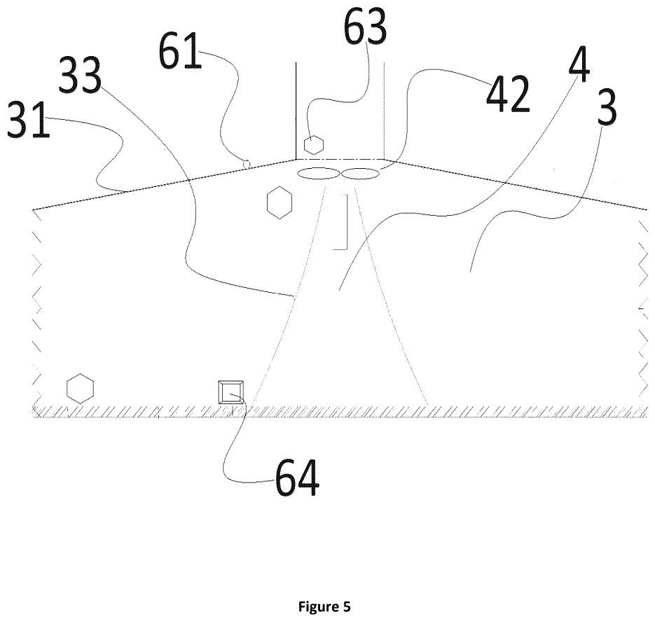

In FIG. 4 and FIG. 5, the locations of said warning elements are shown. First of all, as can be seen from FIG. 4, warning element 2 (62) is positioned on the tail wing (17). In an alternative embodiment of the invention, said warning element 2 (62) is a wind sensor. Warning element 2 (62) is positioned on the tail wing (17) primarily to calculate the wind speed and wind angle. Again, as can be seen from FIG. 4, warning element 5 (65) is positioned at different points in the direction of the first axis (E1), provided that it is inside and on the chimney (2). In an alternative embodiment of the invention, said warning element 5 (65) is a chimney sensor. As a representation of said warning element 5 (65), three of them are shown in the chimney (2) within the scope of the disclosure, and they are increased or decreased according to the length of the chimney (2). The warning element 5 (65) provides information about the air conditions inside the chimney (2). In particular, the temperature rate, humidity amount and wind speed inside the chimney (2) are measured.

In FIG. 5, the connection between the chimney (2) and the greenhouse (3) area is shown in detail. Cover (31) is positioned over the representatively shown greenhouse (3) area. Said cover (31) covers the greenhouse (3) from end to end. The solar beams coming into the greenhouse (3) are transmitted through the cover (31). The main aim of using the cover (31) is to benefit from the solar beams at the most appropriate rate. Based on this situation, in an alternative embodiment of the invention, glass coating, transparent coatings and polycarbonate coating materials are used in said cover (31).

In an alternative embodiment of the invention, a different type of structural connection can be provided between the chimney (2) and the greenhouse (3) for the purpose of storing the heat obtained from sunlight and/or the ambient temperature and/or the heat generated by the operation of the power generation mechanism (4). The heat obtained through these structures are stored and then used in different areas.

As shown in detail in FIG. 5, the power generation mechanism (4) is positioned inside the greenhouse (3) in the same direction as the chimney (2) (in the same direction as the first axis (E1)). The turbine blade (42) is positioned between the power generation mechanism (4) and the chimney (2). The turbine blade (42) provides the initial drive required for the operation of the power generation centre (4) to ensure electricity production in the power production centre (4).

FIG. 5 shows the locations of the warning elements other than the mentioned cases. First of all, warning element 3 (63) is positioned in different areas within the greenhouse (3) and on the cover (31). Said warning element 3 (63) cannot be limited to be three as shown in FIG. 5 within the scope of the disclosure. Its number can be increased or decreased depending on the size and usage volume of the greenhouse (3) area or depending on the detailed information requested by the users about the data.

Warning element 3 (63) is positioned in the base area, middle area and upper area of the greenhouse (3) structure, as shown in FIG. 5, and it is aimed to provide information about every area of the greenhouse (3). In an alternative embodiment of the invention, said warning element 3 (63) is a greenhouse (3) sensor. With warning element 3 (63), information is obtained primarily about the humidity rate in the greenhouse (3), wind speed and the possibility of precipitation, etc.

Again, as can be seen from FIG. 5, warning element 1 (61) is positioned on the upper part of the cover (31). Said warning element 1 (61) is a solar sensor in an alternative embodiment of the invention and is used to calculate the angle of incidence and transmission intensity of the solar beams.

Finally, temperature warning element 4 (64) is positioned inside the greenhouse (3) at the bottom layer according to the first axis (E1) line. The temperature in the greenhouse (3) is measured with the warning element 4 (64).

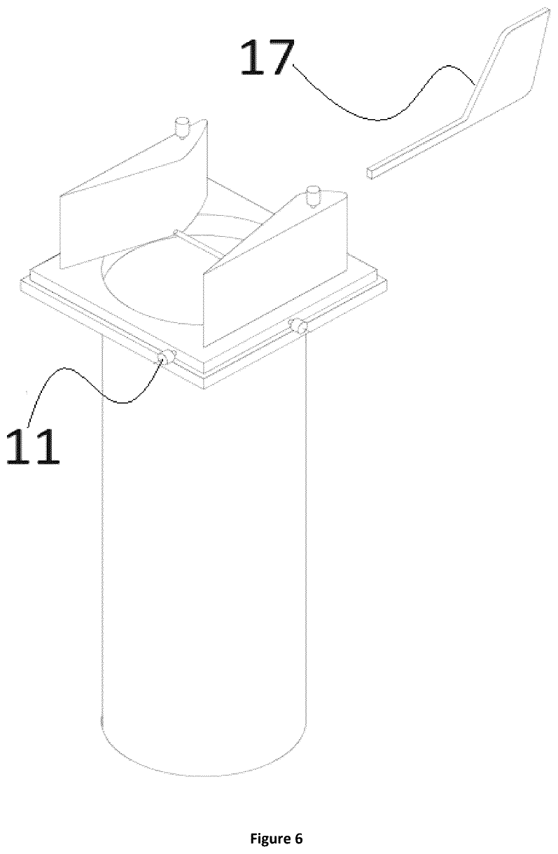

FIG. 6 shows the visual of connecting the tail wing (17) to the wing carrier (12).

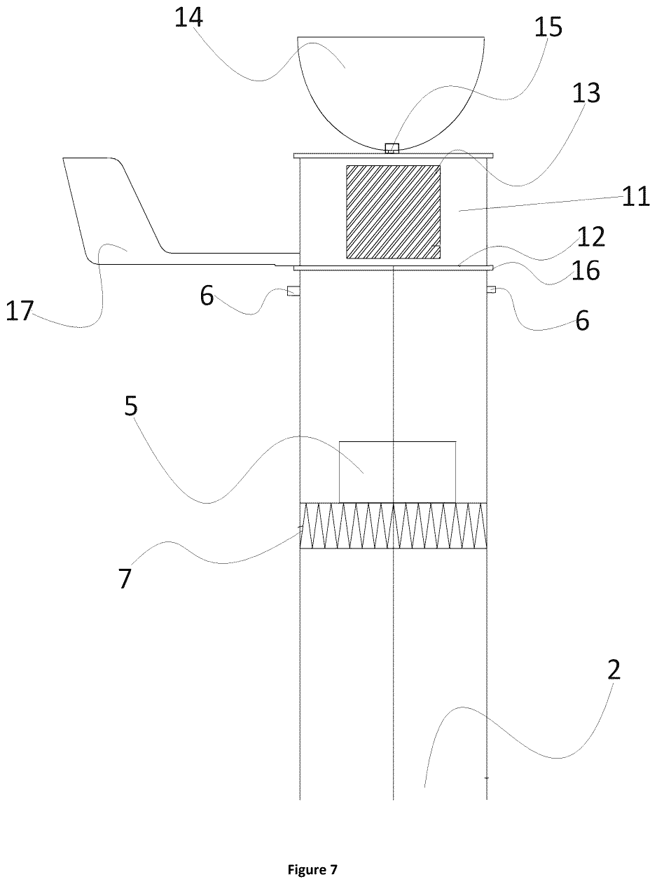

FIG. 7 gives a general view of at least one embodiment the invention. As can be seen from the FIG. 6, the control unit (5) is positioned on the balancing element (7). In this way, the wing structures and/or chimney (2) are not exposed to any reaction during shaking for any reason and/or are prevented from being damaged with minimal shaking.

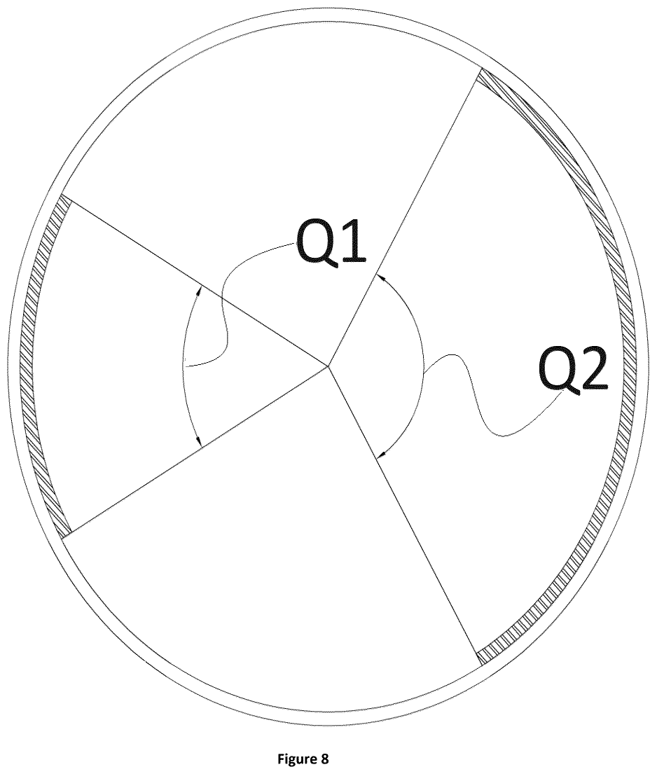

Side openings are shown in FIG. 8. Said side openings consist of the first opening (Q1) and the second opening (Q2). In order to enable the chimney (2) to draw air, the rotation process is provided from the second opening (Q2) to the first opening (Q1). While the first opening (Q1) scans an area of 60°, the second opening (Q2) scans an area of 120°.

The scope of protection of the invention is stated in the attached claims and cannot be limited to what is explained in this detailed description for exemplary purposes. Because it is obvious that a person skilled in the art can produce similar structures in the light of those described above, without deviating from the main theme of the invention.

1. A hybrid solar chimney to provide energy gain, comprising:
at least one chimney in which a suction-draft process (vacuum effect) is created, wherein air has its density reduced by a horizontal wing and at least one greenhouse to heat the air that is in the at least one chimney, wherein the at least one chimney further comprises:
a chimney draft mechanism hat is connected to a top of the at least one chimney to ensure air draft inside the at least one chimney and to ensure operation of the at least one chimney in dark weather and winter seasons when solar rays are insufficient;
the horizontal wing, which divides wind energy transmitted to it the horizontal wing into a top portion and a bottom portion, according to its location, wherein the horizontal wing allows the wind energy at the bottom portion to be faster than the wind energy at the top portion, and wherein the horizontal wing provides the air draft by creating a vacuum effect due to the wind energy at the bottom portion being faster than the wind energy at the top portion;
a first translation element to provide forward-backward movement to the horizontal wing in the direction of a second axis;
a second translation element to provide up-down movement to the horizontal wing (11) in the direction of a first axis;
an angle adjustment element to adjust a position of the horizontal wing according to the wind energy (wind speed) and to ensure use of wind energy at the most appropriate angle;
a tail wing to indicate direction of the horizontal wing in order to ensure that the horizontal wing is constantly oriented towards a direction of the wind;
a slewing bearing to ensure that the tail wing constantly rotates towards the direction of the wind;
a transparent cover to cover the greenhouse;
an air router to ensure that the heated air in the greenhouse is directed to the at least one chimney;
a power generation mechanism to ensure conversion of wind energy (mechanical energy) into electrical energy through alternators;
a turbine blade to provide necessary drive to ensure operation of the power generation mechanism in order to ensure production of electricity within the power generation mechanism;
a warning evaluation unit, in which information coming from sensor groups located in different positions, angles, and directions is first evaluated, the data obtained is compared and controlled according to a predetermined processing range; and
a control unit that processes information received from the warning evaluation unit and, as a result of evaluations of the warning evaluation unit, enables a position of the horizontal wing to be adjusted in case of weather conditions suitable for its operation, provides necessary information to the first translation element, the second translation element, and the angle adjustment element, in order to adjust the direction of the horizontal wing according to the wind direction, and to check control and operation accuracy of the first translation element, the second translation element, and the angle adjustment element.

2. The hybrid solar chimney according to claim 1, further comprising a first warning unit that measures direction angles of solar beams and transfers relevant data to the warning evaluation unit.

3. The hybrid solar chimney according to claim 2, further comprising a second warning unit that calculates wind speed and wind angle and transfers relevant data to the warning evaluation unit.

4. The hybrid solar chimney according to claim 3, further comprising: a third warning unit that calculates air conditions in the greenhouse and transfers the relevant data to the warning evaluation unit.

5. The hybrid solar chimney according to claim 4, further comprising: a fourth warning unit that calculates air temperature, air humidity, and precipitation possibilities and transfers data obtained to the warning evaluation unit.

6. The hybrid solar chimney according to claim 5, further comprising: a fifth warning unit that calculates air conditions inside the at least one chimney and transfers air condition data to the warning evaluation unit.

7. The hybrid solar chimney according to claim 6, wherein the first warning unit, the second warning unit, the third warning unit, the fourth warning unit, and the fifth warning unit are sensors.

8. The hybrid solar chimney according to claim 1, further comprising: a balancing element that is activated in case of load imbalances that may occur on the chimney draft mechanism in the direction of the first axis and/or the second axis and prevents the chimney draft mechanism from being damaged due to the load imbalances.

9. The hybrid solar chimney according to claim 1, wherein the transparent cover (31) is made of individual materials and/or combinations selected from the group consisting of: glass coating, transparent coatings, polycarbonate coating materials, and combinations thereof.

10. The hybrid solar chimney according to claim 1, further comprising: a wing carrier on which the first translation element, the second translation element, and the angle adjustment element are positioned to ensure preservation of the first translation element, the second translation element, and the angle adjustment element.

11. The hybrid solar chimney according to claim 1, further comprising: a second opening and a first opening, wherein scanning areas are determined while the at least one chimney performs the draft (suction) process.

12. The hybrid solar chimney according to claim 11, wherein the second opening is 120° and the first opening is 60°.

13. The hybrid solar chimney according to claim 8, wherein the balancing element is a spring.
